(19) United States
(12) Patent Application Publication
(10) Pub. No.: US 2021/0207775 A1
(43) Pub. Date: Jul. 8, 2021

(54) SYSTEMS FOR REMOVING HYDROGEN FROM REGENERABLE LIQUID CARRIERS AND ASSOCIATED METHODS

(71) Applicant: Kontak LLC, Redmond, WA (US)

(72) Inventors: David O'Connor, North Bend, WA (US); Damien Wilson, Redmond, WA (US)

(21) Appl. No.: 17/059,178

(22) PCT Filed: May 29, 2019
(86) PCT No.: PCT/US2019/034284

§ 371 Date: Nov. 25, 2020

Related U.S. Application Data
(60) Provisional application No. 62/677,640, filed on May 29, 2018.

(51) Int. Cl. F17C 11/00; B01D 19/00; B01D 5/00; C01B 3/00

(52) U.S. Cl. CPC F17C 11/005; B01D 19/0073; H01M 8/04201; B01D 5/0069; C01B 3/0015; B01D 5/006

(57) ABSTRACT

The present technology includes a system for removing hydrogen from a liquid carrier molecule to produce a gaseous hydrogen and an at least partially dehydrogenated liquid carrier that is able to be later recombined with additional hydrogen molecules. In some embodiments, the system for removing hydrogen molecules from the liquid carrier can include a vaporizer unit, one or more modules downstream of and in fluid communication with the vaporizer unit, a condenser unit downstream of and in fluid communication with the one or more modules, and a separator unit downstream of and in fluid communication with the condenser unit.

### CROSS-REFERENCE TO RELATED APPLICATIONS

The present application claims priority to U.S. Provisional App. No. 62/677,640, filed May 29, 2018, titled “SYSTEMS FOR REMOVING HYDROGEN FROM REGENERABLE LIQUID CARRIERS AND ASSOCIATED METHODS” (Attorney Docket No.: 128913-8005.US00), the entire disclosure of which is hereby incorporated by reference herein and made part of the present disclosure. The present application is related to co-pending U.S. Non-Provisional application Ser. No. 15/826,590 filed Nov. 29, 2017, titled “INDUCTIVELY HEATED MICROCHANNEL REACTOR” (Attorney Docket No.: 128913-8001.US01); U.S. Provisional No. (62/677,612), filed May 29, 2018, titled “MODULAR FUELING STATION” (Attorney Docket No. 128913-8002.US00), U.S. Provisional No. (62/677,649), filed May 29, 2018, titled “MULTI FREQUENCY CONTROLLERS FOR INDUCTIVE HEATERS AND ASSOCIATED SYSTEMS AND METHODS” (Attorney Docket No. 128913-8003.US00), and U.S. Provisional No. (62/677,620), filed May 29, 2018, titled “DUAL BLADDER FUEL TANK” (Attorney Docket No. 128913-8006.US00). The entire disclosures of the above-recited related applications are hereby incorporated by reference herein and made part of the present disclosure.

### TECHNICAL FIELD

The present technology is directed generally to systems for removing hydrogen from regenerable liquid carriers. Some embodiments include removing hydrogen from a hydrogenated liquid carrier to produce an at least partially dehydrogenated liquid carrier that can be rehydrogenated with additional hydrogen molecules.

### BACKGROUND

Energy derived from carbon-based fuels continues to be unsustainable and expensive. As such, there is a need to use cleaner and more economical sources of energy, such as hydrogen, to meet the energy demands of today's economy and environmental concerns.

### BRIEF DESCRIPTION OF THE DRAWINGS

FIG. 1 is a schematic diagram of a system for generating hydrogen in accordance with embodiments of the present technology.

FIG. 2A is a front view of a portion of the system shown in FIG. 1 in accordance with embodiments of the present technology.

FIG. 2B is an isometric view of a portion of the system shown in FIG. 1 in accordance with embodiments of the present technology.

FIG. 2C is a side view of a portion of the system shown in FIG. 1 in accordance with embodiments of the present technology.

FIG. 3 is an isometric view of a portion of the system shown in FIG. 1, further including a tank in accordance with embodiments of the present technology.

### DETAILED DESCRIPTION

The present technology is generally directed to systems and methods for removing hydrogen from a liquid carrier, while maintaining the integrity of the liquid carrier such that it can be later rehydrogenated with additional hydrogen molecules. Stated differently, the present technology is generally directed to removing at least some of the hydrogen from a hydrogenated liquid carrier molecule to produce a partially dehydrogenated liquid carrier molecule that can then be rehydrogenated.

In some embodiments, the system for removing hydrogen molecules from the liquid carrier can include a vaporizer unit, one or more release modules downstream of and in fluid communication with the vaporizer unit, a condenser unit downstream of and in fluid communication with the one or more release modules, and/or a separator unit downstream of and in fluid communication with the condenser unit. As described in further detail below, in some embodiments of the present technology, a hydrogenated liquid carrier is vaporized via the vaporizer and then received by one of the release modules. The hydrogenated carrier is then heated via an inductor coil wrapped around the release module, causing gaseous hydrogen to be released from the carrier and thereby produce a dehydrogenated or partially dehydrogenated vaporized carrier. The dehydrogenated carrier and gaseous hydrogen are then routed to the condenser unit which condenses the dehydrogenated carrier into a liquid carrier while maintaining the hydrogen in gaseous form. The gaseous hydrogen and liquid carrier can then be routed to a separator unit where the gaseous hydrogen and liquid carrier are separated based on density differences therebetween. The separated gaseous hydrogen can be routed to an energy-harvesting unit (e.g., a hydrogen fuel cell), and the liquid carrier can be routed to a tank (e.g., where it can be rehydrogenated with additional hydrogen molecules). In some applications, the separated gaseous hydrogen is routed to a compressor configured to pressurize the gaseous hydrogen to a desired pressure (e.g., greater than 350 bar, greater than 700 bar, or some other desired pressure).

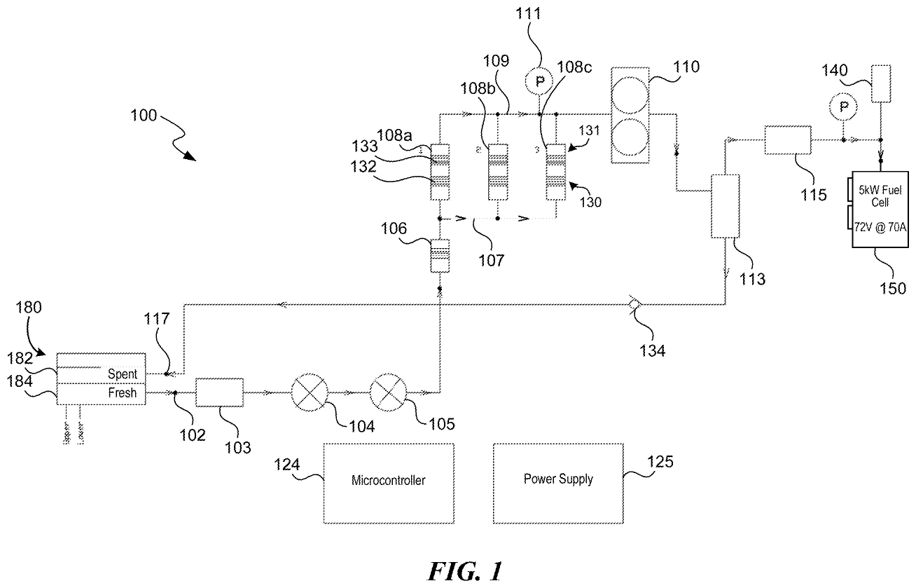

FIG. 1 is a schematic diagram of a system 100 for generating hydrogen in accordance with embodiments of the present technology. As shown in the illustrated embodiment, the system 100 includes a tank (e.g., a dual bladder tank) 180 having a source of hydrogenated liquid carrier stored in a first portion (e.g., a “Fresh” portion) 184 of the tank 180, and a source of at least partially dehydrogenated liquid carrier stored in a second portion (e.g., a “Spent” portion) 182 of the tank 180. Additional details regarding the tank 180 are provided in U.S. patent application No. 62/677,620, entitled DUAL BLADDER FUEL TANK, and filed on May 29, 2018, the disclosure of which is incorporated herein by reference in its entirety.

The hydrogenated liquid carrier stored in the first portion 184 of the tank 180 is directed toward a vaporizer 106. As shown in the illustrated embodiment, prior to being received by the vaporizer 106, the hydrogenated liquid carrier can be routed through a filter 103, a flow meter 104 and a pump 105. The filter 103 can include a porous device that filters particles greater than, e.g., 10 microns, and can help ensure particulate matter is prevented from passing through the pump 105 and causing damage therein. The flow meter 104 is used to measure a volumetric flow rate of the incoming liquid carrier and can be in operable communication with a control system 124. In some embodiments, the flow meter can be a micro paddle type flow meter including multiple chambers for carrying liquid from the inlet side to the outlet side of the flow meter 104. For example, the flow meter 104 can include an optically indexed disk. As liquid is transferred through the flow meter, the optically indexed disk rotates, thereby interrupting an LED and photodiode signal and causing a pulse to be generated. The rate at which the pulses occur is directly proportional to the flow rate through the flow meter 104. In some embodiments, the flow meter can include one or more components configured to generate a signal (e.g., a quantity of electrical energy) as the paddles rotate. The pump 105 can include a positive displacement pump and be operably coupled to a DC motor. The rotational speed of the pump can be governed by a motor speed controller circuit using a standard PID loop. The pump 105 moves the hydrogenated liquid carrier toward the vaporizer, and provides the force needed to generally move the liquid carrier through the system 100.

The vaporizer 106 causes the liquid carrier to be vaporized, or at least partially vaporized, into a vapor-phase carrier. The heat used by the vaporizer 106 to vaporize the liquid carrier can stem from, e.g., an electric heater (e.g., a coil), as is schematically illustrated. Once vaporized, the dehydrogenated carrier is directed toward one or more release modules (e.g., containers, receptacles, or other modules) 108a, 108b, 108c (collectively referred to as “modules 108”). Though only three modules 108 are shown in FIG. 1, additional or fewer modules 108 may be included depending on the rate of hydrogen generation (e.g., Liters per minute) desired. For example, a bank of 16 modules may be included in some systems.

As is further shown in the illustrated embodiment, the modules 108 can connected in parallel to one another. Vaporized carrier from the vaporizer 106 flows to an inlet manifold 107 and then to each of the modules 108. In some embodiments, the inlet ports (e.g., inlet tubing) of individual modules may have different diameters relative to those of other modules to help ensure that an equal amount of carrier flows through each module 108 and/or that a relatively equal amount of hydrogen (i.e., released hydrogen) is produced by each module 108. Since the flow of the vaporized carrier will travel along the path of least resistance, a different amount of the vaporized carrier will want to flow to the inlet port closest to the inlet of the inlet manifold 107, relative to the inlet port farthest from the inlet of the inlet manifold 107. As such, in some embodiments and to help ensure the flow of carrier is evenly distributed among each of the modules 108, the diameter(s) of the inlet ports and/or inlet tubing for each module 108 closer to the inlet manifold 107, relative to other inlet ports and/or inlet tubing, may be smaller or larger relative to other inlet ports that are farther from the inlet manifold. In some embodiments, the adjusted diameter(s) will be preset and fixed, whereas in other embodiments, the diameter(s) may be dynamically adjusted. In embodiments in which the diameter(s) may be dynamically adjusted, the adjustment can be based on feedback associated with the individual inlet port or tubing (e.g., flow rate, temperature, pressure, etc.). Based at least in part on some results obtained as of the filing of this application, increasing the diameter of the inlet port closest to the inlet of the inlet manifold has shown to aid in evenly distributing the flow of carrier among each of the modules 108. The specific diameter of each inlet port can be determined according to the following equation:

$$Δ P + \frac{ρ f}{2 D} {W}^{2} Δ X + \frac{ρ}{2} Δ {W}^{2} = 0$$

where
W is velocity,
P is pressure,
ρ is density,
D is hydraulic diameter,
f is frictional coefficient,
X is the axial coordinate of the manifold,
ΔX=L/n, with n being the number of ports and L being the length of the manifold.
   The pressure drop is assumed to be proportional to the flow rates. In addition to or in lieu of the above, the specific diameter of each inlet port can also be determined by computational fluid dynamics modeling. As described in further detail below, adjusting the diameter of the inlet ports for each module 108 can help indirectly maintain a uniform temperature across a diameter of the individual modules 108 when in operation.

The modules 108 cause at least a portion of hydrogen to be released from the hydrogenated vaporized carrier, and thereby transition the hydrogenated vaporized carrier to an at least partially dehydrogenated vaporized carrier. The partially dehydrogenated vaporized carrier can have less than about 20%, less than about 15%, or less than about 12% hydrogen by weight, relative to the hydrogenated vaporized carrier. In a preferred embodiment, the dehydrogenated vaporized carrier is only partially dehydrogenated, as opposed to completely dehydrogenated, to ensure it can be recombined with additional hydrogen to form the hydrogenated carrier. Stated differently, the dehydrogenated vaporized carrier can be only partially dehydrogenated to ensure it can be fully dehydrogenated with little or no degradation of the carrier in between cycles.

As shown in the illustrated embodiment, individual modules 108 can include a first heating portion 130 and a second heating portion 131 downstream of the first heating portion 130. A first heating coil 132 can be positioned at and/or around the first heating portion 130, and a second heating coil 133 can be positioned at and/or around the second heating portion 131. The first and second heating coils 132, 133 can be in communication with and controlled by the microcontroller 124. The first heating portion 130 and the first heating coil 132 can be configured to heat the hydrogenated vaporized carrier to a target temperature prior to the hydrogenated vaporized carrier entering the second heating portion 131. In some embodiments, the target temperature can be from a range of about 120 degC to about 180 degC, or about 130 degC to about 170 degC, or about 135 degC to about 150 degC, or at about 140 degC. Notably, the temperature of the carrier entering the second heating portion should be kept within a predetermined temperature range, based at least in part on the carrier used, to ensure the vaporized hydrogenated carrier does not degrade and become unable to be rehydrogenated at a later time. For example, on one hand, if the carrier temperature is too high, the carrier can decompose into various other undesired molecules and cause issues (e.g., coking and lining the passageway). On the other hand, if the carrier temperature is too low, the hydrogen will not be released from the hydrogenated carrier, or a less than desired amount of hydrogen will be released from the hydrogenated carrier.

The second heating portion 131 can include a reactor core, which has a plurality of individual channels for the hydrogenated vaporized carrier to pass through. The reactor core can further include two or more regions extending along a length of the core that may be individually heated by the second coil 133. The individual channels can be at least partially coated with a catalyst (e.g., cobalt) to promote the release of hydrogen from the hydrogenated vaporized carrier. Notably, the temperature of the core, and thus the catalyst, should be kept within a predetermined temperature range (e.g., the predetermined temperature ranges described above), based at least in part on the carrier and catalyst used, to ensure the vaporized hydrogenated carrier does not degrade and become unable to be rehydrogenated at a later time. Additional details of the reactor core and heating thereof are described in U.S. patent application Ser. No. 15/826,590, entitled INDUCTIVELY HEATED MICROCHANNEL REACTOR, and filed on Nov. 29, 2016, the disclosure of which is incorporated herein by reference in its entirety. The fluid exiting the second heating portion 131 (i.e., the core) of the modules 108 includes partially dehydrogenated vaporized carrier and gaseous hydrogen, as well as remaining hydrogenated vaporized carrier for which hydrogen was not released from. The ratio of dehydrogenated to hydrogenated vaporized carrier exiting the second heating portion can represent a conversion efficiency of the module, and can be improved by adjusting the temperature of the core and/or the carrier entering and passing through the core to be at the target temperature or within the target temperature range described above. Notably, the dehydrogenated vaporized carrier exiting the core is configured to be re-hydrogenated with additional hydrogen molecules. Stated differently, the process of releasing hydrogen from the hydrogenated carrier to produce the dehydrogenated carrier is performed in a manner that does not degrade or decompose the dehydrogenated carrier.

The fluid exiting the second heating portion 131 flows to an outlet manifold 109 which collects the fluids (i.e., the gaseous hydrogen, dehydrogenated vaporized carrier and unreacted hydrogenated vaporized carrier) from each of the individual release modules 108. In some embodiments, the outlet manifold 109 can include a buffer vessel to help equalize the pressure of the combined fluids, and thereby ensure a more consistent back-pressure is applied to the modules 108. As mentioned above, the outlet manifold 109 and/or buffer vessel can help maintain the modules 108 at their target temperature and thus increase conversion efficiency of the hydrogenated carrier into dehydrogenated carrier. A pressure sensor 111 may be included and in communication with the microcontroller 124. Based on a pressure signal from the pressure sensor 111, the microcontroller 124 may make adjustments to the pump 105 and/or the heating of the modules 108 via one or more of the first coil 132 or second coil 133.

The combined hydrogen and dehydrogenated vaporized carrier are directed from the outlet manifold 109 to a condenser unit 110. The condenser unit 110 can comprise one or more cooling units, and be configured to condense the partially dehydrogenated vaporized carrier and any unreacted hydrogenated vaporized carrier to a partially dehydrogenated liquid carrier and unreacted hydrogenated liquid carrier, respectively. In some embodiments, the fluid exiting the condenser unit 110 can have its temperature decreased via the condenser unit 110 to be approximately ambient or room temperature. The cooling units can include a heat exchanger that cools the fluid via convection. Notably, the boiling point of hydrogen is below room temperature and thus the hydrogen in the fluid exiting the condenser unit 110 remains in a vaporized state.

The fluid exiting the condenser unit 110 enters a separator or collector unit 113 in which the gaseous hydrogen is separated (e.g., extracted) from the dehydrogenated and hydrogenated liquid carrier molecules, based at least in part on density differences between the gaseous hydrogen and liquid carrier molecules. Accordingly, the gaseous hydrogen exits through a top portion of the separator 113 and the liquid carrier exits through a bottom portion of the separator 113. The gaseous hydrogen can be directed to a hydrogen filter 115 and thereafter to other applications. For example, the gaseous hydrogen can be directed to a hydrogen fuel cell 150. The hydrogen filter 115 can include, e.g., activated charcoal or carbon, and can further purify the gaseous hydrogen by removing unwanted molecules therefrom. A hydrogen sensor 140 positioned downstream of the filter 115 can be in communication with and controlled by the microcontroller 124. Based on a signal from the hydrogen sensor 111 (e.g., a hydrogen analyzer), the microcontroller 124 can determine conversion efficiency of the module 108 and/or production rate of the overall system 100, and may adjust the pump 105 and/or the heating of the modules 108 via one or more of the first coil 132 or second coil 133.

The liquid carrier exiting the separator 113 can be directed back to the tank 180, or more specifically, to the spent portion 182 of the tank 180. In some embodiments where the tank 180 is stored at an elevation below that of the separator 113, the line between the separator 113 and the tank 180 may include a check valve 134 to prevent backpressure from the spent portion 182 from effecting the system 100 (e.g., from inhibiting optimal production of gaseous hydrogen). In other embodiments (e.g., where the tank 180 is stored at an elevation above that of the separator 113), the line between the separator 113 and the tank 180 can include a pump for moving the liquid carrier from the separator 113 to the spent portion 182.

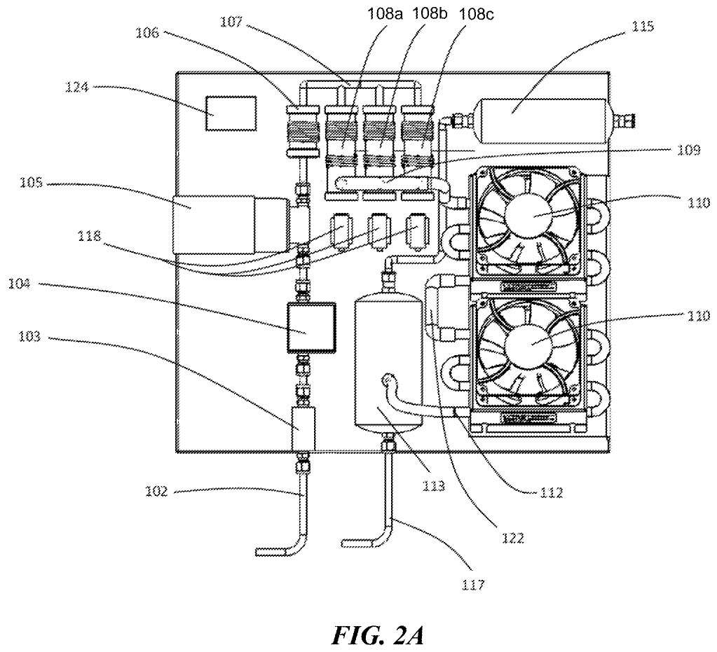

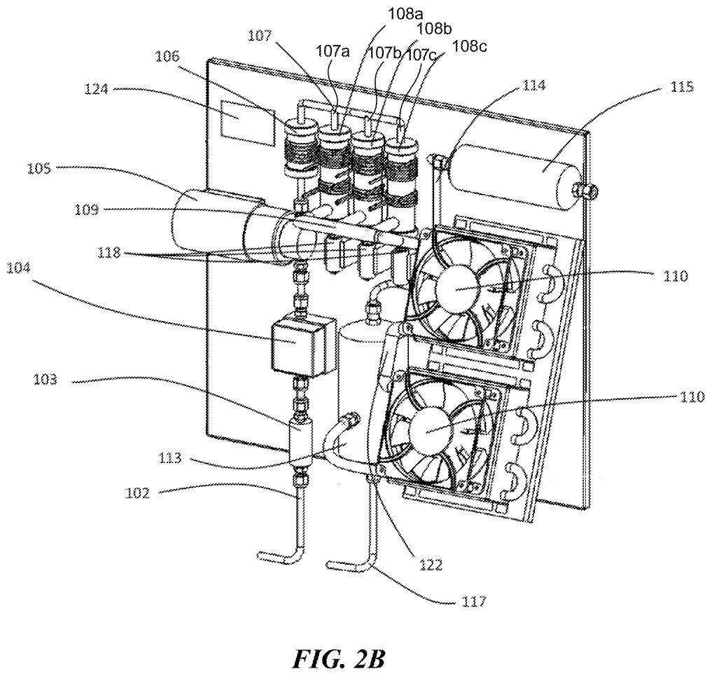

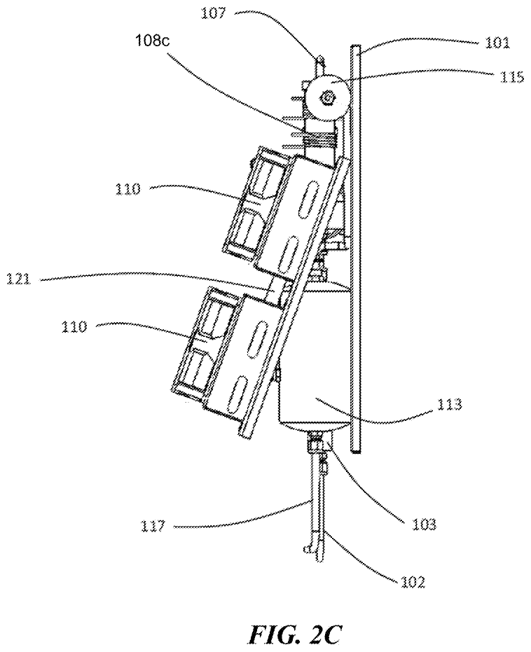

FIG. 2A is a front view of a portion of the system 100 shown in FIG. 1, FIG. 2B is an isometric view of the portion of the system 100, and FIG. 2C is a side view of the portion of the system 100, configured in accordance with embodiments of the present technology. FIGS. 2A-2C illustrate a more detailed view of many of the structures previously referred to in FIG. 1. For example, FIGS. 2A-2C includes the filter 103, flow meter 104, pump 105, vaporizer 106, inlet manifold 107, release modules 108, outlet manifold 109, condenser unit 110, separator 113 and hydrogen filter 115. Additionally, the illustrated embodiments show temperature measurement devices 118. The temperature measurement devices 118 can be in communication with the microcontroller 124, and can be used to determine a temperature profile of the release modules 108. Each temperature measurement device 118 can be positioned proximate the release module 108 it is measuring. As shown in the illustrated embodiment, the individual temperature measurement devices 118 are positioned directly below the corresponding release modules 108 such that an end view of module 118, or core, can be viewed. The temperature measurement device 118 can include an imaging component, such as an infrared thermal imager. The imaging component, positioned to capture an end view of the core, can collect temperature measurements of individual regions across a diameter of the core. The measurements can then be stored in memory associated with the microcontroller 124, e.g., as 10 bit words. In some embodiments, the resolution of the infrared imager can be 640×480 pixels. In a preferred embodiment, the resolution is high enough to look at individual channels within the core. The imaging component can form a virtual image of a temperature profile within the core, and the virtual image can then be quantized and used by the microcontroller 124 to control the temperature. Other devices, such as a thermocouple or resistance temperature detector (RTD), can also be in used in addition to or in lieu of the cameras described above.

In operation, the core of each module 108 is heated via the second coil 133 using oscillating electrical signals to provide a uniform temperature gradient across the core. Each electrical signal sent to the second coil 133 has a unique frequency that corresponds to heating the core to a particular depth relative to an outer surface of the core. For example, a first frequency can heat a first depth of the core, and a second frequency can heat a second depth of the core that is greater than the first depth. Accordingly, as the microcontroller 124 oscillates between these different electrical signals having different frequencies, the core is heated at different depths of penetration. The measurements collected from the temperature measurement device 118 can be used to adjust the electrical signals if the measured temperature for a particular region is less than a target temperature for that region. For example, if a measured temperature of a region of the core is less than a target temperature, then a duty cycle associated with the electrical signal meant to heat that region can be increased to thereby direct more heat to that region. As another example, if a measured temperature of a region of the core is higher than a target temperature, then a duty cycle associated with the electrical signal meant to heat that region can be decreased to thereby direct less heat to that region. Additional details regarding heating of the core are provided in U.S. patent application No. 62/677,649, entitled MULTI-FREQUENCY CONTROLLERS FOR INDUCTIVE HEATING AND ASSOCIATED SYSTEMS AND METHODS, and filed on May 29, 2018, the disclosure of which is incorporated herein by reference in its entirety.

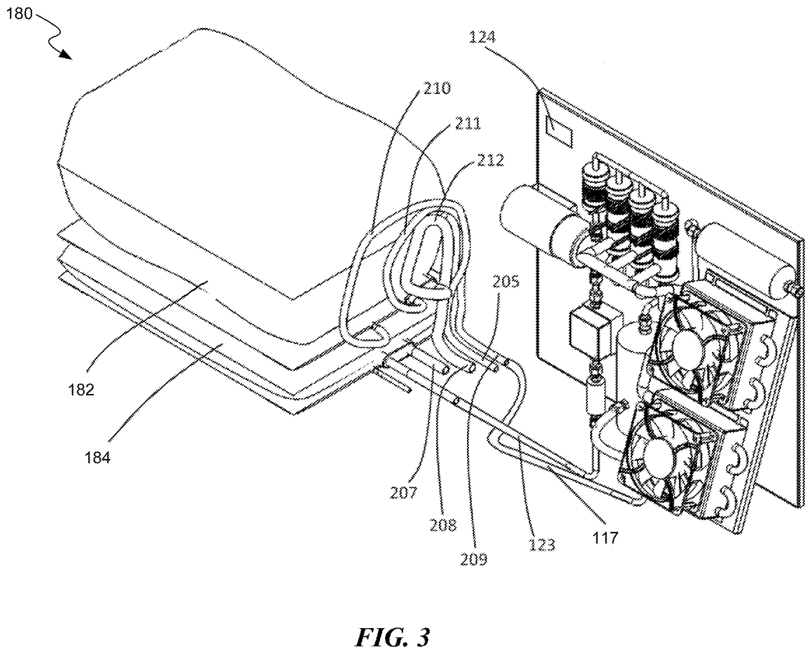

FIG. 3 is an isometric view of the system shown in FIGS. 2A-2C, further including a tank 180 in accordance with embodiments of the present technology. As described above with reference to FIG. 1, the tank 180 includes a first portion 184 and a second portion 182 on top of the first portion 184. The second portion 182 is in fluid communication with the separator 113 via line 117, and the first portion 184 is in fluid communication with the pump 105 via line 123. Additional details regarding the tank 180 are provided in U.S. patent application No. 62/677,620, entitled DUAL BLADDER FUEL TANK, and filed on May 29, 2018, the disclosure of which has been incorporated above.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A system for removing hydrogen from a liquid carrier, the system comprising:
a vaporizer configured to receive a hydrogenated liquid carrier and produce a hydrogenated vaporized carrier;
a module in fluid communication with the vaporizer and configured to receive the hydrogenated vaporized carrier, the module including a heated core portion, wherein the module is configured to produce gaseous hydrogen and an at least partially dehydrogenated vaporized carrier;
a condenser in fluid communication with the module and configured to condense the at least partially dehydrogenated vaporized carrier to produce an at least partially dehydrogenated liquid carrier; and
a separator configured to receive the at least partially dehydrogenated liquid carrier and the gaseous hydrogen from the condenser, wherein the separator is further configured to separate the at least partially dehydrogenated liquid carrier and the gaseous hydrogen based on density.

2. The system of claim 1 wherein the heated core portion includes an inductively-heated coil configured to heat the hydrogenated vaporized carrier to a target temperature prior to the hydrogenated vaporized carrier entering the core portion of the module.

3. The system of claim 2 wherein the module includes an inner layer and an outer layer surrounding the inner layer, the inner layer being in direct contact with the hydrogenated vaporized carrier passing through the module, the system further comprising a microcontroller configured to control individual heating of the outer layer and/or of the inner layer via the inductively-heated coil.

4. The system of claim 2, further comprising a sensor configured to detect an internal temperature at the heated core portion, and a controller operably coupled to the sensor and configured to maintain a target temperature at the heated core portion by sending an electrical signal to the coil.

5. The system of claim 4 wherein the target temperature is within a range from about 130 degC to about 150 degC.

6. The system of claim 4, wherein the target temperature is less than about 200 degC.

7. The system of claim 1 wherein the module is a first module, the system further comprising:
a second module arranged in parallel to the first module,
a first inlet port corresponding to the first module,
a second inlet port corresponding to the second module, and
an inlet manifold in fluid communication with the first and second modules via the first and second inlet ports, respectively.

8. The system of claim 7 wherein the first inlet port is positioned closer to an outlet of the vaporizer than the second inlet port, and wherein the first inlet port has a first diameter and the second inlet port has a second diameter larger than the first diameter.

9. The system of claim 7, further comprising a buffer vessel between the condenser and the first and second modules, wherein the buffer vessel is in fluid communication with outlets of the first and second modules, wherein the buffer vessel is configured to at least partially equalize pressure differences between the first and second modules.

10. The system of claim 1 wherein the carrier includes an amine.

11. The system of claim 1 wherein the gaseous hydrogen from the separator is directed to an energy harvesting device.

12. The system of claim 1, further comprising a bladder tank including a first tank portion having the hydrogenated liquid carriers to be received by the vaporizer, and a second tank portion configured to receive the dehydrogenated liquid carrier from the separator.

13. The system of claim 2 wherein the second tank portion is positioned above the first tank portion.

14. The system of claim 1 wherein at least a portion of the heated core portion is coated with a catalyst material to promote release of the hydrogen from the hydrogenated vaporized carrier.

15. The system of claim 14 wherein the catalyst includes cobalt.

16. The system of claim 1 wherein the at least partially dehydrogenated vaporized carrier and the at least partially dehydrogenated liquid carrier are only partially dehydrogenated.

17. The system of claim 1 wherein the at least partially dehydrogenated vaporized carrier includes between about 5% to about 20% less hydrogen by weight relative to the hydrogenated vaporized carrier.

18. The system of claim 1 wherein the at least partially dehydrogenated liquid carrier is configured to be rehydrogenated.

19. A method for removing hydrogen from a liquid carrier, the method comprising:
vaporizing a hydrogenated liquid carrier to produce a hydrogenated vaporized carrier;
directing the hydrogenated vaporized carrier through a core of a module, thereby causing the hydrogenated liquid carrier to produce gaseous hydrogen and a dehydrogenated vaporized carrier;
condensing the dehydrogenated vaporized carrier to form a dehydrogenated liquid carrier; and
separating at least a portion of the produced gaseous hydrogen and the dehydrogenated liquid carrier into separate streams, wherein the dehydrogenated liquid carrier is configured to be rehydrogenated.

20. The method of claim 19 wherein the dehydrogenated vaporized carrier is only partially dehydrogenated.

21. The method of claim 19, further comprising heating the core of the module to a target temperature via an inductively-heated coil controlled by a microcontroller.

22. The method of claim 21 wherein the target temperatures is within a range from about 130 degC to about 150 degC.

23. The method of claim 21 wherein the target temperature is about 140 degC.
